(19) United States
(12) Patent Application Publication
(10) Pub. No.: US 2006/0055310 A1
(43) Pub. Date: Mar. 16, 2006

(54) Field emission device, and method of manufacturing such a device

(75) Inventors: Teunis Johannes Vink, Eindhoven (NL); Marcus Antonius Verschuuren, Eindhoven (NL); Murray Fulton Gillies, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/538,096

(22) PCT Filed: Nov. 12, 2003
(86) PCT No.: PCT/IB03/05170

§ 371 Date: Jun. 8, 2005

(30) Foreign Application Priority Data
Dec. 13, 2002 (EP) 02080269.0

(51) Int. Cl. H01J 63/04

(52) U.S. Cl. 313/495; 313/311

(57) ABSTRACT

A field emission device (100) is provided with a cathode electrode (120) and a gate electrode (140). Between these electrodes, a patterned dielectric layer (130) is provided. According to the invention, this dielectric layer (130) is manufactured from a liquid precursor material (131) which is patterned by means of a liquid embossing step, i.e. engaging a patterned stamp (150) with the liquid material (131). After removing the stamp (150), the liquid material is cured to form the patterned dielectric layer (130). Preferably, in a subsequent manufacturing step, the cathode electrode (120) or the gate electrode (140) is formed over the patterned dielectric layer (130) in a self-aligned way.

The invention relates to a method of manufacturing a field emission device.

The invention further relates to a field emission device and to a display device comprising such a field emission device.

The field emission device may be used as an electron source for a flat-panel type display, the so-called Field Emission Display (FED). The FED is a vacuum electronic device, sharing many common features with the well-known Cathode Ray Tube (CRT), such as low manufacturing costs, good contrast and viewing angle and no required back-lighting.

Field emission is a quantum-mechanical phenomenon in which electrons tunnel through a potential barrier at an outer surface of a suitable emitter material, as a result of an applied electric field. The presence of the electric field makes the width of the potential barrier at said outer surface finite, so that this potential barrier is permeable for electrons. Thus, electrons may be emitted from the field emitter material.

A field emission device commonly employs a gate structure (also called triode structure). The gate structure includes field emitter material and two electrodes, namely a cathode electrode and a gate electrode. Between these electrodes, in operation, an electric field is formed which allows emission of electrons from the field emitter material, which is usually located adjacent to the cathode electrode.

In a field emission display, the field emission device employs two sets of electrodes, more particularly a set of cathode electrodes and a set of gate electrodes. The sets of electrodes generally define a passive matrix structure of rows and columns. Thereby, the electric field, and thus the electron emission current, may be modulated independently for each pixel on the display screen of the field emission display.

For obtaining a sufficiently high strength of the electric field over the field emitter material, the cathode and gate electrodes should generally be close to each other. To achieve this, a dielectric layer is provided between the sets of electrodes. Such a dielectric layer is then usually patterned.

For example, in a normal configuration of the gate structure, a cathode electrode is provided on a substrate, and a dielectric layer and a gate electrode are arranged over the cathode electrode. Gate holes are provided extending through the dielectric layer and the gate electrode. The field emitter material is provided adjacent the cathode electrode, at the bottom of the gate holes. Thus, the dielectric layer (and the gate electrode) have to be provided with these gate holes, through which emitted electrons pass. The gate holes are preferably relatively small, having for example a size of one or a few micrometers, in order to obtain good electron emission from the field emitter.

Conventionally the deposition of the dielectric layer is carried out by means of a chemical vapor deposition (CVD) technique. In the deposited layer, the desired pattern, for example the pattern of the gate holes, is formed by means of photolithography, which involves the step of providing and illuminating a photo layer and an etching step. In the example of the normal configuration of the gate structure, the etching step preferably comprises reactive ion etching (RIE) in order to obtain gate holes with sufficiently steep slopes. Moreover, the CVD and RIE techniques require vacuum equipment.

Because of these issues, known methods of manufacturing of the field emission device are time-consuming. The required equipment is expensive, for example, the maintenance and operating costs of a CVD apparatus are relatively high.

It is therefore an object of the invention to provide a method of manufacturing a field emission device, which is both faster and cheaper than conventional methods.

This object is achieved by a method of manufacturing a field emission device according to the invention as specified in the independent Claim 1.

Thus, the dielectric layer of the gate structure is formed from a layer of liquid material, which can easily be provided on the substrate, for example by means of spinning or dip-coating.

The liquid layer is embossed by engaging a stamp with the layer of liquid material. The surface of the stamp generally includes a pattern of protrusions and/or recesses, which pattern matches the desired pattern in the dielectric layer. A suitable stamp for use in the method is for example disclosed in the international patent application WO 97/06012. Preferably, the stamp is formed from an elastomeric material, for example silicone rubber. An elastomeric stamp allows for a good contact between the stamp and the liquid layer to be patterned, without risk of damaging the substrate.

The stamp is in contact with the liquid layer during the engaging step. Thus, the liquid layer is embossed in accordance with the pattern of the stamp. After the stamp has been removed, a curing step is carried out, during which the now patterned layer of liquid material is converted into a solid, patterned dielectric layer.

The method according to the invention is significantly simplified as compared to conventional methods. Vacuum conditions are not required. The layer of dielectric material is applied in liquid form, for example by spinning, instead of growing the layer by means of a CVD technique. No photolithography and etching are needed, but the dielectric layer is patterned by means of a simple and fast embossing technique. As a result, the manufacturing of the field emission device takes only a few minutes, as compared to several hours in the prior art. The equipment required for carrying out the method is relatively simple and cheap as compared with, amongst others, the prior art CVD and etching apparatuses. An etching step is no longer required for patterning the dielectric layer, and thus the field emission device does not have to be provided with an etch-stop layer.

By means of the method according to the invention, patterns at a micron or sub-micron scale may be formed in the dielectric layer with relative ease. The size of the structures in the dielectric layer may be as small as 200 nanometers, or even less. Patterns on this scale are difficult to form by means of conventional photolithography, as this would require illumination with ultra-violet radiation having a wavelength around 200 nanometers. Such radiation easily damages the applied materials.

Generally, by means of the method according to the invention, any desired pattern can be applied to the dielectric layer, by using a stamp matching the desired pattern.

Further advantageous embodiments of the manufacturing method are specified in the dependent claims 2-6.

The surface of the stamp has a pattern of recesses and/or protrusions.

Generally, in the normal configuration of the gate structure, the emitter material is provided in gate holes in the dielectric layer.

Such gate holes are preferably formed by engaging suitably shaped protrusions of a stamp with the liquid layer. Said protrusions are more preferably cylindrically shaped. A cathode electrode is located adjacent to the substrate and the field emitter material, and a gate electrode provided with apertures for passing the emitted electrons, which apertures are substantially aligned with the gate holes, is located on the other side of the field emission device, as seen from the substrate.

Alternative suitably shaped protrusions are cylindrically shaped while comprising a tapered portion facing away from the substrate during the engaging step. Thereby, a portion of the gate hole has a diameter that increases with the distance to the substrate.

The gate structure of a field emission device may alternatively be in an undergate configuration. The substrate then comprises the gate electrode, and a pattern of patches of dielectric material are laid out on top of the gate electrode. The patches of dielectric material are embossed by means of a stamp comprising a similar pattern of suitably shaped recesses. The recesses in the stamp are preferably cylindrically, annularly or rectangularly shaped for manufacturing the undergate triode structure.

An additional pressure may be exerted on the stamp during the engaging step, said pressure being set to a predetermined value. By exerting an additional pressure, the stamp and the liquid layer are in more intimate contact.

By using a very small or even zero pressure, the stamp is drawn onto the liquid layer due to capillary forces. For example in a normal gate configuration, this causes a thin layer of dielectric material to remain under the protrusions of the stamp and thus in the gate holes, the thickness of such a layer being for example 50 or 100 nanometers. This is advantageous when emitter particles of the metal-insulator-vacuum type are used, such as graphite particles. If such particles are applied before the embossing step, a thin layer of insulating material covering the particles is left after the patterning of the liquid layer. This ensures good emission properties of these particles.

If additional pressure is used, the stamp and liquid layer are in more intimate contact, so that in the example above less liquid material remains in the gate hole. If desired, a gate hole in which substantially no liquid material remains may be formed. In a field emission device, the cathode electrode is then exposed at the bottom of the gate hole.

A suitable liquid material for use in the method includes, amongst others, a hydrolysis mixture of an organosilane compound such as methyl tri methoxy silane (MTMS) and colloidal silica (Ludox TM50 ex Dupont) particles (see the co-pending European patent application PHNL021231). This liquid layer is a so-called sol-gel precursor system forming a dielectric layer based on a siloxane matrix and silicondioxide. This dielectric layer has good insulating properties and a sufficiently low dielectric constant.

Alternatively, polyamide can be used as the liquid material. When using polyamide, it is particularly advantageous that a prior art etching step such as a reactive ion etching (RIE) step, is not necessary. Such etching may cause polyamide to graphitize under certain circumstances, which degrades the properties of the formed dielectric layer because the graphite being formed defines a conductive path.

In the prior art, the dielectric layer and the electrode on top of said layer are patterned simultaneously. When using the method according to the invention, the electrode is provided over the patterned dielectric layer in a subsequent step, preferably in a self-aligned way.

Preferably the step of forming the second electrode comprises the further steps of
providing a suspension comprising metal particles on a secondary stamp;
transferring part of said suspension onto elevated portions of the patterned dielectric layer, and
annealing of the transferred suspension.

This technique is referred to as “gravure offset printing” in the following.

The suspension comprises metal particles, the metal being for example silver or aluminum, and is transferred onto the dielectric layer by means of a secondary stamp. This secondary stamp is usually unpatterned.

This stamp is brought into contact with a further substrate on which suspension is provided, so that part of the suspension is picked up by the secondary stamp. After that, the secondary stamp is engaged with the patterned dielectric layer, leaving part of the suspension on elevated portions of the dielectric layer. Only the elevated portions of the dielectric layer are in contact with the secondary stamp.

Finally, an annealing step is carried out to obtain a conductive metal layer forming the second electrode from the transferred suspension. The annealing is done at an elevated temperature, for example 350 degrees Celsius. The second electrode is only provided at the elevated portions of the dielectric layer, and is thus self-aligned with the pattern provided therein.

The gravure offset printing process is able to form a self-aligned electrode on any pre-patterned dielectric layer. It is not necessary that the dielectric layer is patterned by means of the liquid embossing technique set out in the above.

Alternatively, providing the electrode in a self-aligned way is done by contact printing of metal particles onto the patterned dielectric layer. Subsequently, the printed metal particles can be used to grow a continuous metal film constituting the second electrode, for example by means of electroless deposition technique. This process relies on the use of a suitably patterned mask in the printing step.

It is a further object of the invention to provide a field emission device that has relatively low manufacturing costs, and may be manufactured in a relatively short period of time. This further object is achieved by the field emission device according to the invention as specified in claim 7. Further preferred embodiments are specified in dependent claims 8-11.

The field emission device comprises a triode structure including a gate electrode and a cathode electrode. Field emitter material is arranged adjacent the cathode electrode. Between the gate electrode and the cathode electrode, a patterned dielectric layer is provided. According to the invention, the patterning of said layer is carried out by means of a liquid embossing technique, in which a patterned stamp is engaged with a liquid layer.

In a preferred embodiment, the triode structure has a normal configuration comprising a dielectric layer with a pattern of gate holes for passing emitted electrons. More preferably, the gate holes comprise a tapered portion adjacent the second electrode, the second electrode extending at least partly into the tapered portion of the apertures.

The latter feature has the advantage that for the largest part of the gate structure, the distance between the first electrode and the second electrode may be relatively large leading to a relatively small electric capacitance of the gate structure. At the same time, the electric field near the emitter material, in operation, remains at a sufficiently high level, due to the second electrode extending into the gate holes.

These and other aspects of the present invention will be apparent from and elucidated with reference to the appended drawings.

In the drawings:

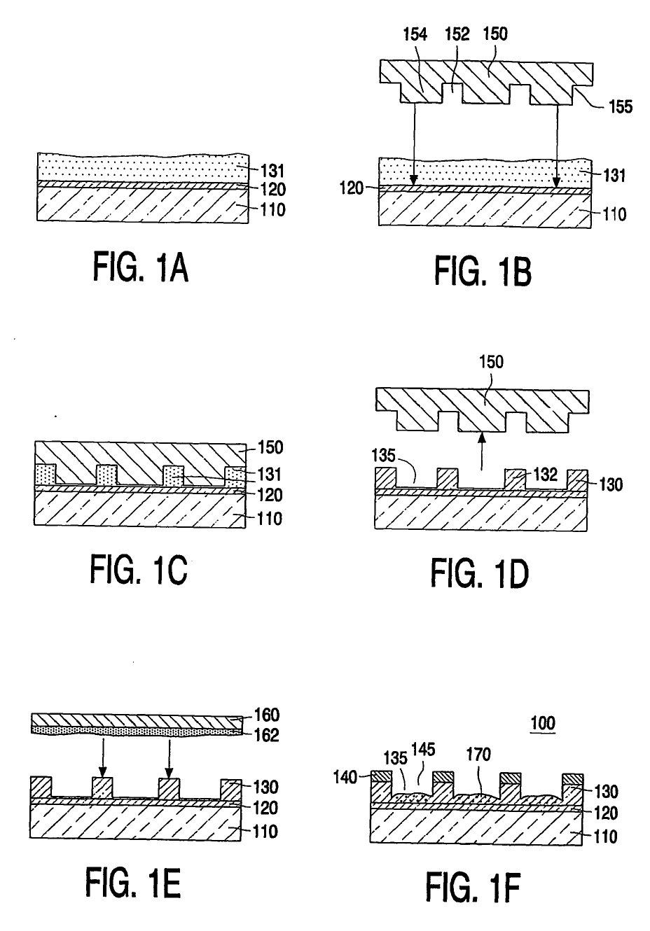

FIGS. 1A-1F illustrates a method of manufacturing an embodiment of a field emission device having a normal gate structure, according to the invention;

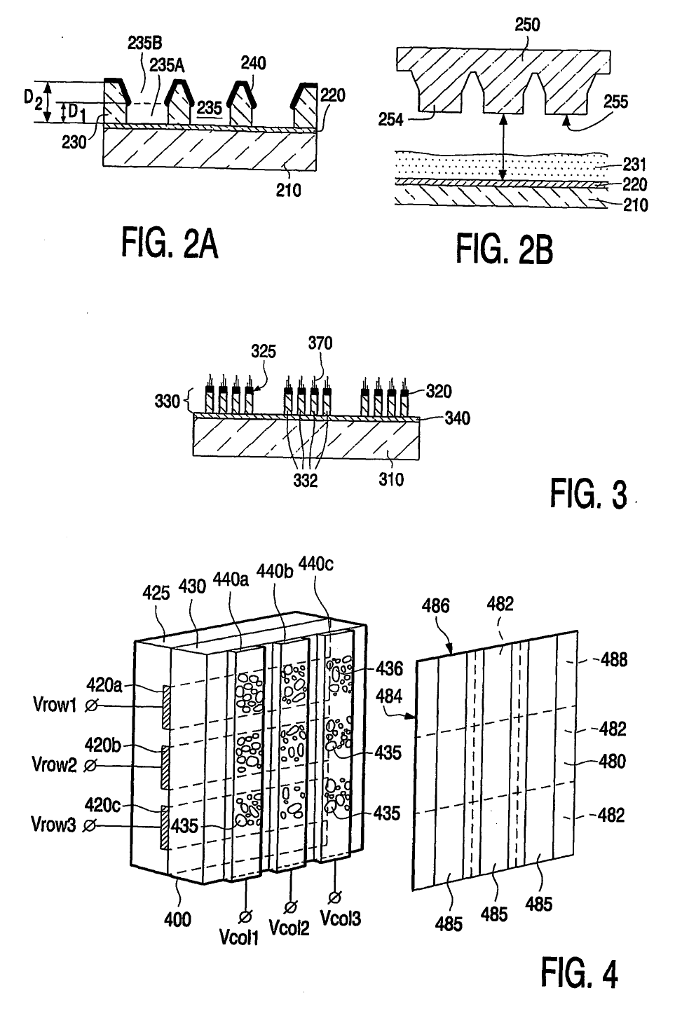

FIG. 2A-2B shows a further embodiment of a field emission device having a normal gate structure;

FIG. 3 shows an embodiment of a field emission device having an undergate structure, according to the invention, and

FIG. 4 shows an embodiment of a Field Emission Display (FED).

A gate structure (triode structure) for a field emission device is manufactured by means of an embodiment of the method according to the invention. In FIG. 1, the manufacturing of a field emission device 100 having a triode structure in a so-called normal gate configuration is illustrated.

A substrate 110, for example a glass plate, is firstly provided with a cathode electrode 120. A layer 131 of liquid material is provided over the substrate 110 and the cathode electrode 120. The layer 131 preferably has a thickness between 1 and 10 micrometer, and is deposited on the substrate 110 by means of, amongst others, a spinning process, a screen-printing technique or a dip-coating process. The liquid material is preferably a sol-gel type suspension of colloidal silica (Ludox TM50) and methyl tri-methoxy silane (MTMS). Alternatively, the liquid material comprises polyamide.

In a subsequent engaging step (FIG. 1B), an elastomeric stamp 150 is brought into contact with the layer 131 of the liquid material. The stamp 150 is for example made of PDMS, which is a silicone rubber. The surface 155 of the stamp 150 that is brought into contact with the liquid material during the engaging step comprises a pattern of recesses 152 and protrusions 154.

When the stamp is brought into contact with the layer 131 (FIG. 1 C), liquid material is pushed away by the protrusions 154 but remains within the recesses 152. Thereby, the layer 131 of liquid material is given an embossed pattern, which matches the pattern of recesses 152 and protrusions 154 on the stamp 150. This process is called “soft lithography” or “liquid embossing”. Preferably, the stamp 150 comprises cylindrically shaped protrusions 154, so that cylindrically shaped holes are formed in the layer 131.

A first curing step is carried out wherein the layer 131 is heated to a temperature of 70 degrees Celsius for 2-3 minutes. This ensures that the layer 131 maintains its pattern during the subsequent step of removing the stamp 150 from the layer 131.

After removing the stamp 150, a second curing step is carried out whereby the layer 131 is heated to an elevated temperature of preferably around 400 degrees Celsius. During the second curing step, the liquid material in the layer 131 is converted to a solid dielectric layer 130. In case the liquid material includes the above-mentioned sol-gel type suspension, the solid dielectric material comprises silicondioxide, and the dielectric constant of the solidified layer is around 4. The patterned dielectric layer 130 is shown in FIG. 1D.

Patterning of the dielectric layer 130 by means of liquid embossing is particularly advantageous when emitter particles of the metal-insulator-vacuum (MIV) type are used. Optimal emission by such particles relies on a thin layer of insulating material being present on the outer surface of the (conductive) particle.

In this case, preferably, emitter particles (indicated by reference sign 170 in FIG. 1F) are provided directly over the substrate 110 and cathode electrode 120 by means of any suitable technique, such as spin-coating or dip-coating. Thus, the emitter particles are provided before the layer 131 of liquid material is applied. The emitter particles are for example graphite particles having an average diameter of 4 micrometers.

If no additional pressure is applied to the stamp 150 during the embossing step, the stamp 150 is drawn onto the liquid layer 131 only by capillary forces, and a relatively thin layer of liquid material, for example a 70 nanometers layer, remains on the substrate 110 and cathode electrode 120. The elastomeric stamp 150 folds around the emitter particles, so that a similar thin layer of liquid material remains over the emitter particles 170. In this way a dielectric layer having the required thickness is provided over the particles upon removing the stamp and solidifying the liquid material.

The dimensions of the gate holes 135 in the dielectric layer 130 that are obtained by applying the method are for example between 1 and 10 micrometers.

Preferably, the dimensions of the gate holes 135 are substantially the same as the thickness of the dielectric layer 130 itself, so that the gate holes 135 have a 1:1 aspect ratio. Such gate holes are suitable when the above-mentioned MIV-type emitter particles are used, or alternatively when Spindt-type emitter tips are applied.

Gate hole dimensions in the sub-micron region, such as 200 or 500 nanometers, have been achieved. Such dimensions may be advantageous when certain types of emitter material are used, for example carbon nanotubes (CNTs). With carbon nanotubes, it is desirable to have gate holes that are as small as possible, as this allows for more efficient emission of electrons. This requirement originates from the fact that only carbon nanotubes adjacent to the rim of the gate hole contribute to the electron emission. Therefore, with decreasing gate hole size the number of emitting particles increases.

During a final step, the structure is provided with a gate electrode 140 on top of the patterned dielectric layer 130. This gate electrode 140 has a pattern of apertures 145 for passing emitted electrons, which apertures 145 are aligned with the gate holes 135. Conventionally, the apertures 145 and the gate holes 135 are formed using a single etching step, however in the method according to the invention the gate electrode 140 is provided after patterning the dielectric layer 130.

The gate electrode 140 is formed in a self-aligned manner, thus in such way that the electron passing apertures 145 are aligned with the gate holes 135 of the dielectric layer 130.

A preferred way of forming the gate electrode 140 in a self-aligned manner is the gravure offset printing technique illustrated in FIG. 1E. A further, substantially unpatterned, stamp 160 is provided with a suspension of metal particles, for example silver (Ag) or aluminum (Al). This suspension is for example transferred onto the stamp 160 from a substrate (not shown) on which the suspension is provided, preferably by means of printing.

The surface 162 of the secondary stamp 160, on which surface the suspension is provided, is then engaged with the formed gate structure, and is more specifically brought into contact with elevated portions 132 of the dielectric layer 130. Thus, part of the suspension is deposited onto the dielectric layer 130. The secondary stamp 160 is then removed and the second electrode 140 is formed from the deposited suspension by means of an annealing step. Since suspension is only deposited onto the elevated portions 132 of the dielectric layer, and not inside the gate holes 135, the formed second electrode 140 is self-aligned with the patterned dielectric layer 130.

The final device that is obtained by the process set out in the above is shown in FIG. 1F. In this drawing, the emitter particles 170 are indicated. It is noted that according to the described embodiment of the manufacturing method, the particles 170 are provided on top of the cathode electrode 120, before the layer 131 of liquid material is applied. However, the emitter particles 170 are only shown in FIG. 1F, for clarity reasons.

The emitter particles, such as carbon nanotubes (CNTs), may also be provided as a final step of the method, for instance by means of a printing technique employing a mask. Into larger gate holes (above 10 micron) the CNTs can then be printed using a photosensitive paste. Alternatively, for smaller gate holes (below 10 micron) the CNTs could be directly grown.

The thickness of the dielectric layer is chosen to strike a balance between sufficiently high electron emission and relatively limited capacitance of the emitting structure. A thinner insulator generates higher electric fields near the emitter material, so that electron emission is relatively high. However, the capacitance of the structure is inversely proportional to the thickness of the insulator, so that a thinner dielectric layer leads to a larger capacitance.

In a field emission display, the larger capacitance leads to several disadvantages in the driving of the pixels. Amongst others, the amount of energy that is lost in driving the pixels is relatively large, the pixel addressing is relatively slow due to an increased RC time, and capacitive current losses occur when a pixel is addressed. For these reasons, the preferred thickness of the dielectric layer is between 1 and 10 micrometers. Moreover, in a preferred embodiment of the field emission device, the dielectic layer is patterned as shown in FIG. 2A. The gate holes 235 in the dielectric layer 230 comprise a cylindrical portion 235A adjacent to the substrate 210 with the field emitter material (not shown), and a tapered portion 235B adjacent the gate electrode 240. The gate electrode 240 covers the inside wall of the tapered portion 235B, and thus extends into the gate hole 235 until a distance D1 from the cathode electrode 220.

The diameter of the gate holes near the cathode electrode 220 is for example 10 micrometers, which increases to for example 12 micrometers at the gate-electrode end of the tapered portion 235B. The thickness D2 of the dielectric layer 230 is for example 6 micrometers. The cylindrical portion 235A and the tapered portion 235B of the gate holes both extend through approximately half of the dielectric layer 230, so that their lengths in the direction perpendicular to the substrate 210 are about 3 micrometers. D1 is thus also about 3 micrometes.

The thickness D2 of the dielectric layer 230 is relatively large to avoid problems with too high pixel capacitance. On the other hand, due to the gate electrode 240 extending into the gate hole, the electric field at the location of the field emitter material is determined by the relatively small distance D1. Calculations for the example described above have shown that the pixel capacitance is reduced by 45%, while the electric field at the field emitter material is only reduced by 2%. Thus, this arrangement provides a high emission field with a relatively small capacitance.

The dielectric layer 230 is embossed with a stamp 250 having protrusions 254 with a tapered portion, as shown in FIG. 2B. Thus the gate holes 235 comprising a tapered portion 235B are obtained. The gate electrode 240 extending into the gate holes 235 is formed by the gravure offset printing technique set out earlier, whereby the thickness of the suspension layer brought onto the secondary stamp determines the amount of extension of the gate electrode 240 into the gate holes 235.

A similarly shaped gate hole per se is known from the prior art, for instance from international patent application WO 92/01305. However, in this document, the different portions of the gate hole are formed separately, in separate dielectric layers. By virtue of the manufacturing method according to the invention, a gate hole that partially has a tapered shape may be manufactured with relative ease, in a single embossing step. The gate hole extends in a single dielectric layer.

It is relatively easy to optimize the design of the gate holes, so as to allow for further reductions in capacitance. From a manufacturing point of view, this requires only a change in the pattern of the stamp.

In a field emission device, the position of the cathode electrode and the gate electrode can also be interchanged, so that the gate electrode is adjacent to the substrate. This is called an undergate structure. An embodiment of a field emission device with an undergate structure is shown in FIG. 3.

The manufacturing method for the undergate structure is largely the same as for the normal gate structure. The gate electrode 340 is firstly provided on the substrate 310, and subsequently covered with liquid material from which a patterned dielectric layer 330 is formed by means of liquid embossing. The cathode electrode 320 is preferably formed by means of the gravure offset printing technique, on top of the patterned dielectric layer 330.

In manufacturing the undergate structure, the emitter particles 370 have to be deposited after forming the cathode electrode 320. In the drawing, carbon nanotubes are shown as emitter particles 370, but any other suitable field emitter material may be applied. The emitter particles 370 may for example be provided by means of a second gravure offset printing step, whereby a suspension comprising the emitter particles is transferred onto a substantially unpatterned stamp, which is subsequently brought into contact with the cathode electrode 320. After depositing the suspension on top of the cathode electrode 320, the suspension is annealed so that emitter particles 370 remain.

In an undergate structure, emission of electrons predominantly occurs by emitters adjacent to the rim 325 of the cathode electrode 320. It is therefore advantageous if a relatively large number of small structures is formed, as is shown in FIG. 3. The dielectric layer 330 comprises a relatively large number of patches 332 of insulating material, each being covered with the cathode electrode 320 and emitter material 370.

The manufacturing method according to the invention is particularly suitable for forming such structures, since it allows for the formation of patterns having dimensions in the sub-micron regime.

In a Field Emission Display as shown in FIG. 4, a vacuum envelope comprises a field emission device 400 according to the invention. The field emission device opposes a display screen 480 provided with phosphor tracks 485. The display screen 480 comprises picture elements 482. The field emission device 400 is used as an electron source, for generating the electrons that impinge on the phosphor tracks 485, thereby illuminating picture elements 482.

Each picture element (pixel) 482 of the display screen 480 is addressable individually, therefore the cathode electrodes and gate electrodes define a passive matrix structure. For each row 484 of pixels 482, a row cathode electrode 420a ,b ,c is provided, and for each column 486 of pixels 482, a column gate electrode 440a ,b ,c is provided.

The cathode electrodes 420a , b, c are separated from the column gate electrodes 440a ,b, c, by a patterned dielectric layer 430. The layer is formed from a converted liquid material, for example from a sol-gel type material comprising an organosilane compound and preferably an inorganic filler material such as colloidal silica. Alternatively, the liquid material comprises polyamide.

The pattern of the dielectric layer 430 is a pattern of gate holes 435. At the bottom of each gate hole 435, emitter particles (not shown) are provided which emit electrons when a suitable electric field is applied. The gate holes 435 extend through the dielectric layer 430 and the gate electrodes 440a, b, c.

The power consumption of the Field Emission Display should be as low as possible, so it is desirable to have a low voltage difference between the cathode electrode and the gate electrode. Also, the dielectric constant of the dielectric layer should be low, so that the capacitance of the field emission device is also relatively small. The thickness of the dielectric layer has to strike a balance between having a relatively high electric field at said low voltage difference on the one hand, and having a relatively low capacitance on the other hand.

In a preferred embodiment, the dielectric constant of the dielectric layer 130 is 3,5 or 4. The thickness of the dielectric layer 130 is about 20 micrometers. In this case, a voltage difference between cathode electrode and gate electrode of about 20 Volts allows for a sufficiently high electric field over the emitter particles at the bottom of the gate holes 435, so that these particles are able to emit electrons.

A pixel 482 is addressed by switching on the row voltage Vrowl,2,3 of the row cathode electrode 420a ,b,c corresponding to that pixel and simultaneously switching on the column voltage Vcoll,2,3 of the column gate electrode 440a, b, c, corresponding to that pixel. Then, only the emitter particles in a region at the intersection of the selected cathode and gate electrodes emit electrons, which pass through the gate holes of said region and are accelerated towards the display screen 480. For this purpose, the display screen 480 is supplied, in operation, with an anode voltage of for example 10 kVolts. The accelerated electrons land on a pixel 482 of the display screen 480, whereby the part of a phosphor track 485 within said pixel 482 is energized and illuminates.

By way of example, when row voltage Vrow1 and column voltage Vcol3 are switched on, electrons are released from a pattern of apertures indicated in the drawing by reference numeral 436, and land on the display screen 480 at the selected pixel indicated by reference sign 488. Because of this, the phosphor track 485 within the selected pixel 488 illuminates, rendering the selected picture element 488 visible to a viewer.

The drawings are schematic and were not drawn to scale. While the invention has been described in connection with preferred embodiments, it should be understood that the invention should not be construed as being limited to the preferred embodiments. Rather, it includes all variations which could be made thereon by a skilled person, within the scope of the appended claims.

Summarizing, a field emission device (100) is provided with a cathode electrode (120) and a gate electrode (140). Between these electrodes, a patterned dielectric layer (130) is provided. According to the invention, this dielectric layer (130) is manufactured from a liquid precursor material (131) which is patterned by means of a liquid embossing step, i.e. engaging a patterned stamp (150) with the liquid material (131). After removing the stamp (150), the liquid material is cured to form the patterned dielectric layer (130). Preferably, in a subsequent manufacturing step, the cathode electrode (120) or the gate electrode (140) is formed over the patterned dielectric layer (130) in a self-aligned way.

1. A method of manufacturing a field emission device, comprising the steps of
providing a layer of liquid material on a substrate;
engaging a patterned stamp with said layer of liquid material, for embossing the layer,
curing the layer of liquid material, thereby forming a solidified, patterned dielectric layer, and
forming an electrode on said patterned dielectric layer.

2. The method of claim 1, wherein the method comprises engaging substantially cylindrical protrusions of the stamp with the layer of liquid material.

3. The method of claim 1, wherein the method comprises exerting an additional pressure on the stamp during the engaging step, said pressure being set to a predetermined value.

4. The method of claim 1, wherein the liquid material comprises a hydrolysis mixture of an organosilane compound and an inorganic filler material.

5. The method of claim 1, wherein the liquid material comprises polyamide.

6. The method of claim 1, wherein the step of forming the electrode comprises the further steps of
providing a suspension comprising metal particles on a secondary stamp;
transferring part of said suspension onto elevated portions of the patterned dielectric layer, and
annealing of the transferred suspension.

7. A field emission device, comprising
a field emitter material for emitting electrons;
a first electrode and a second electrode for applying an electric field over said field emitter material and
a dielectric layer substantially in between said first and second electrodes, said dielectric layer being patterned by means of a liquid embossing technique.

8. The field emission device of claim 7, wherein the dielectric layer comprises a pattern of gate holes for passing emitted electrons.

9. The field emission device of claim 8, wherein the gate holes comprise a tapered portion adjacent the second electrode, the second electrode extending at least partly into the tapered portion of the gate holes.

10. The field emission device of claim 7, wherein the field emitter material comprises carbon nanotubes.

11. The field emission device of claim 7, wherein the field emitter material comprises a graphite particular emitter.

12. A display device, comprising a field emission device according to claim 7.
